(19) United States
(12) Patent Application Publication
(10) Pub. No.: US 2025/0257185 A1
(43) Pub. Date: Aug. 14, 2025

(54) SYSTEM AND METHOD FOR PURIFYING RECYCLED POLYPROPYLENE USING RECLAIMED SOLVENT

(71) Applicant: Purecycle Technologies, Inc., Orlando, FL (US)

(72) Inventors: Scott Brown, Moses Lake, WA (US); Jason Vititoe, Flatwoods, KY (US); Chris Talarek, Liberty Township, OH (US); George Schilowsky, Paramus, NJ (US)

(21) Appl. No.: 18/441,416

(22) Filed: Feb. 14, 2024

(51) Int. Cl. C08J 11/02; B01D 3/06; B01D 11/02

(52) U.S. Cl. CPC C08J 11/02; B01D 3/06; B01D 11/0288; B01D 11/0296; C08J 2323/12

(57) ABSTRACT

A system and method for continuously purifying contaminated polymers, such as polypropylene, at a commercial scale. In one embodiment, the system and method involves obtaining reclaimed plastic, mixing the reclaimed plastic with a solvent, purifying the mixture through decanting and devolatilization steps, and recycling the reclaimed solvent back into the system.

### FIELD OF DISCLOSURE

The present invention generally relates to a system and method for continuously purifying contaminated plastics, such as polypropylene polymers, at a commercial scale.

### BACKGROUND

Mechanical recycling is used commonly in the United States to convert plastic waste into a reusable format for subsequent manufacturing. However, there are several limitations to the mechanical recycling process that result in poor quality recycled plastic materials. Specifically, recycled (processed) plastic pellets often contain contaminants and mixtures of dyes and pigments from the original plastic articles. To overcome these limitations, several methods have been developed to purify contaminated plastics. One such example is dissolution recycling, which produces a recycled plastic that is odorless, colorless, and without a significant amount of contamination.

The process of dissolution recycling polypropylene is known in the art. Numerous patents have addressed the solvent dissolution recycling using a heavy solvent such as in U.S. Patent Publication No. US2023/0174736A1, WIPO Publication No. WO2022/223491 A2 or WIPO Publication No. WO2022/219090 A1. Other patents have addressed the idea of solvent dissolution recycling using a light solvent such as in U.S. Pat. Nos. 10,899,906, 11,008,433, and 10,961,366. The art does not, however, describe how to execute the requisite steps continuously at a large scale. Specifically, U.S. Pat. No. 9,834,621 describes a solvent dissolution recycling process in which the examples are limited to approximately 250 g of recycled material at a time.

Operation of solvent dissolution recycling at large scale involves management of several non-ideal conditions (including non-Newtonian fluids, sticking solids, high viscosity fluids, and multiphase flows). Solvent dissolution recycling requires a high ratio of solvent to polymer in order to create dilute polymer solutions. For operation at large scale, it is critical to develop a method to contact the polymer with the solvent, recover the solvent after the polymer is purified and recycle the solvent back to the purification process. The use of recycled material as a feedstock also leads to wide variation in mechanical properties, creating a need to design a process to accommodate each of these potential complications at large scale.

Accordingly, a need still exists for an improved method to purify contaminated plastics continuously and at a large scale.

### SUMMARY OF DISCLOSURE

The present invention is directed to a system and method for continuously purifying contaminated polymers. The system and method comprises the steps of obtaining reclaimed plastics and a feed loading step to convert solid plastics into molten material such that it can be conveyed as a flowable liquid. The system and method also comprises a solvent contacting step to ensure molten plastic and solvent are sufficiently mixed into a molten plastic-solvent mixture. The molten plastic-solvent mixture is allowed to settle and is filtered in order to purify the reclaimed plastic. Further, the system and method comprise decanting and devolatizing steps to recover solvent and purify the reclaimed plastics. Further steps, such as solvent flash, solvent condensation, and solvent pressurization steps are implemented to recycle the solvent back into the purification process.

While some of steps are disclosed in the prior art (including U.S. Pat. No. 10,899,906), it has been found that several additional steps are required to successfully operate an effective continuous dissolution recycling process at a commercial scale.

An embodiment of the present invention discloses a method for purifying a reclaimed plastic comprising the steps of: (a) obtaining reclaimed plastic material wherein the reclaimed plastic material is comprised of post-consumer use plastics, post-industrial use plastics, or combinations thereof; (b) contacting the reclaimed plastic with a solvent having a boiling point of less than or equal to 70 degrees Celsius to form a reclaimed plastic-solvent mixture; (c) extracting contaminants from the reclaimed plastic-solvent mixture; (d) dissolving the further reclaimed plastic-solvent mixture in a second additional solvent to produce a mixture of plastic-solvent solution and undissolved contaminants; (e) separating the undissolved contaminants from the further reclaimed plastic-solvent mixture by settling the further reclaimed plastic-solvent mixture in a vessel with a residence time of at least 5 minutes and filtering the further reclaimed plastic-solvent mixture through a filter media to create a second further reclaimed plastic-solvent mixture; (f) purifying the second further reclaimed plastic-solvent mixture with a solid absorbent media; (g) recovering the solvents from the second further reclaimed plastic-solvent mixture; and (h) recycling at least 97% of all the solvent used in the method through a solvent recovery and purification step.

Step (b), contacting the reclaimed plastic with solvent further comprises the steps of: (i) mixing the solvent with the reclaimed plastic material; and (ii) diffusing the solvent into the reclaimed plastic material.

Step (c), extracting contaminants further comprises the steps of: (i) contacting the plastic-solvent mixture with an additional solvent; (ii) absorbing dissolved contaminants from the reclaimed plastic-solvent mixture into the additional solvent to create a contaminated solvent; (iii) producing a first stream comprised of a further reclaimed plastic-solvent mixture which proceeds to the step of separating undissolved contaminants from the further reclaimed plastic-solvent mixture; and (iv) producing a second stream comprised of the contaminated solvent which proceeds to a solvent recovery and purification step.

Step (g), recovering the solvents from the second further reclaimed plastic-solvent mixture further comprises the steps of: (i) decanting the second further reclaimed plastic-solvent mixture to remove a portion of the solvents from the second further reclaimed plastic-solvent mixture; and (ii) devolatilizing the second further reclaimed plastic-solvent mixture to remove at least a portion of any remaining solvent from the second further reclaimed plastic-solvent mixture.

Step (h), the solvent recovery and purification step, further comprises: (i) using a plurality of flash vessels to recycle the solvents and remove contaminants from the solvents recovered from the decanting, devolatilization, and extraction steps, wherein the solvent flash vessels operate at a temperature between 50 degrees and 200 degrees Celsius and a pressure between 0 to 200 psig to vaporize the solvents into a solvent vapor and separate the solvents from liquid and solid contaminants; (ii) using a plurality of heat exchangers to condense the solvent vapor to a solvent liquid for collection in a plurality of liquid collection vessels; and (iii) using a plurality of pumps to pressurize and recycle the liquid solvent back into the method.

A second embodiment of the present invention discloses a second method for purifying a reclaimed plastic comprising: (a) obtaining reclaimed plastic material wherein the reclaimed plastic material is comprised of post-consumer use plastics, post-industrial use plastics, or combinations thereof; (b) contacting the reclaimed plastic with a solvent having a boiling point of less than or equal to 70 degrees Celsius to form a reclaimed plastic-solvent mixture, wherein the solvent absorbs a plurality of contaminants from the reclaimed plastic; (c) recovering the solvent from the reclaimed plastic-solvent mixture; (d) processing the reclaimed plastic to form a final plastic product having an opacity and yellowness index of less than 20; and (e) recycling solvent extracted from the reclaimed plastic-solvent mixture, through a solvent recovery and purification step, to create a purified plastic.

A third embodiment of the present invention discloses a system of recycling solvent used in connection with dissolution recycling, the system comprising: (a) a dissolution recycling system for recycling reclaimed plastic; (b) a plurality of solvent flash vessels to recover and vaporize contaminated solvent from the dissolution recycling system; (c) a plurality of heat exchangers to condense the vaporized solvent to a purified liquid solvent; (d) a plurality of liquid collection vessels to collect the purified liquid solvent; and (e) a plurality of solvent pressurization pumps to recycle collected purified liquid solvent back into the dissolution recycling system.

The solvent vessels of step (b) further comprise: (i) a high point outlet for vapor solvent and a low point inlet for vapor liquid; and (ii) a low point outlet for contaminants and a high point inlet for makeup solvent.

A fourth embodiment of the present invention discloses a system for continuously purifying reclaimed polypropylene comprising: (a) an extruder capable of converting solid recycled polypropylene material into a molten polypropylene; (b) a pipe to carry the molten polypropylene, the pipe comprising at least one inlet to mix an initial amount of liquid solvent with the molten polypropylene; (c) a solvent extraction vessel comprising a first outlet and a second outlet to separate a first stream of recovered molten polypropylene from a second stream of the contaminated liquid solvent; (d) a settling vessel comprising an outlet at the bottom of the settling vessel to remove undissolved contaminants from the recovered molten polypropylene to create a further recovered molten polypropylene; (e) a decanter vessel to collect and decant the further recovered molten polypropylene, the decanter vessel comprising a first outlet for the purified molten polypropylene and a second outlet for recovered liquid solvent; (f) a devolatization vessel to remove solvent vapor from the purified molten polypropylene, the devolatization vessel comprising a first outlet for solvent vapor and a second outlet for further purified molten polypropylene; (g) at least one solvent flash vessel to vaporize solvent and separate liquid and solid contaminants; (h) at least one condensation vessel to condense the vapor solvent into a liquid; (i) at least one solvent pump to return an amount of liquid solvent to the system; and (j) wherein the ratio of liquid solvent returned to the system is at least 90% of the solvent used.

Wherein the liquid solvent of step (b) mixes with the molten polypropylene to form a molten polypropylene-solvent mixture and the liquid solvent absorbs contaminants from the molten polypropylene.

Wherein the at least one solvent flash vessel of step (g) comprises a high point outlet for vapor solvent and a low point outlet for liquid vapor

### BRIEF DESCRIPTION OF THE DRAWINGS

FIG. 1 is a flow diagram depicting a first embodiment of a system and method for continuously purifying contaminated polymers at a commercial scale.

FIG. 2 is a flow diagram depicting a second embodiment of a system and method for continuously purifying contaminated polymers at a commercial scale.

FIG. 3 is a flow diagram depicting a third embodiment of a system and method for continuously purifying contaminated polymers at a commercial scale.

FIG. 4 shows the pounds of product produced over time and the corresponding opacity of such products.

FIG. 5 illustrates the contaminants removed from waste plastic by the steps outlined herein.

FIG. 6 is a plot of yellowness index and opacity versus cumulate recycled plastic production.

FIG. 7 displays families of contaminants removed from waste plastic using the steps outlined herein.

FIG. 8 is a comparison of volatile organic compounds in waste plastic, purified plastic, and virgin plastic.

FIG. 9 shows the rate of purified plastic production and the corresponding opacity of the product.

### DETAILED DESCRIPTION

This disclosure as a whole may be best understood by reference to the following detailed description when read in conjunction with the accompanying drawings, drawing descriptions, abstract, background, field of disclosure, and associated headings. Identical reference numbers when found on different figures identify the same elements or a functionally equivalent element. The elements listed in the abstract are not referenced but nevertheless refer by association to the elements of the detailed description and associated disclosure.

The following terms are used throughout this disclosure in connection with the following definitions:

“Residence Time” is the average amount of time that a material spends in a given process vessel. This metric is approximated by dividing the vessel volume by the volumetric flow rate of the material.

“Yellowness Index” provides a measure of the degree of color shift in plastic from colorless or white to yellowness. The yellowness index is calculated from the intensity of the three primary color values measured using a spectrophotometer.

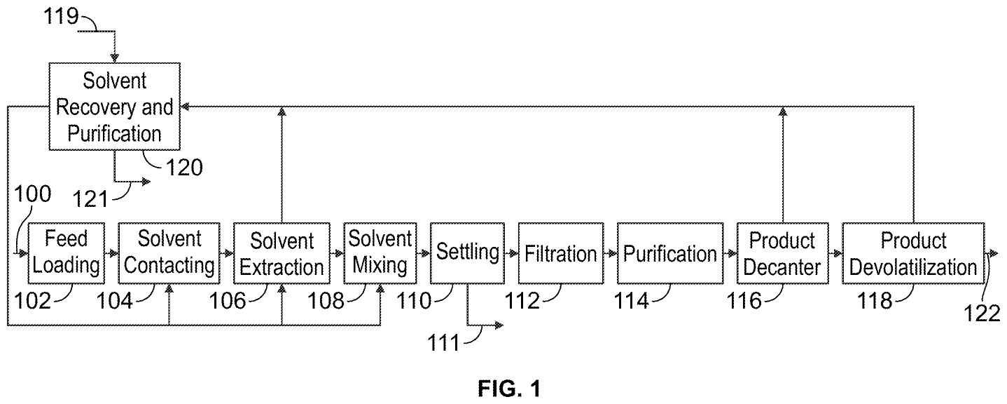

“Makeup Solvent” consists of solvent that is added into a purification process in order to replace small amounts of solvent that are lost or are removed from the purification process. The makeup solvent is represented by streams 119, 219, and 319 in FIGS. 1, 2, and 3, respectively.

“Light Byproduct” consists of the contaminants removed from the contaminated solvent during the Solvent Recovery and Purification Step 120, 220, 320. The Light Byproduct is represented by streams 121, 221, and 321.

“Heavy Byproduct” consists of the contaminants removed from the molten plastic-solvent mixture during the product settling step 110, 210, 310. The Heavy Byproduct is represented by streams 111, 211, and 311.

Light Byproduct is comprised of contaminants having a higher solubility in solvent than Heavy Byproduct.

### First System and Method for Purifying Contaminated Plastics

The embodiment of FIG. 1 depicts the steps of a continuous dissolution recycling process.

The embodiment of FIG. 1 includes a feed loading step to convert solid plastics into molten material such that it can be conveyed as a flowable liquid. Further, the system and method comprise a solvent contacting step to ensure molten plastic and solvent are sufficiently mixed into a molten plastic-solvent mixture. However, an important aspect of a continuous dissolution recycling process is the ability to efficiently remove the solvent from the molten plastic-solvent mixture and reclaim the solvent so that it can be reintroduced to the purification process. It has been found that solvent recovery is most efficiently recovered by decanting and devolatilizing the plastic-solvent mixture.

The decanting step removes a portion of the solvent from the plastic-solvent mixture, while maintaining the solvent in liquid phase. The devolatilization step vaporizes the solvent as it is removed from the plastic-solvent mixture. The liquid and vapor portion of the recovered solvent is purified in the solvent recovery step and recycled to the process.

In an embodiment of the present disclosure, additionally, a portion of the liquid solvent may be recycled directly back into the purification process using a low head recycle pump to maintain circulation.

Each of the above identified steps are described in detail below.

### Feed Loading System

In the embodiment depicted in FIG. 1, the system and method of purifying reclaimed plastic 100 includes obtaining reclaimed plastics which are sourced from post-consumer, post-industrial, post commercial, and/or other waste streams. For the purposes of the present invention, the reclaimed plastics may comprise a homogenous composition of a single plastic or a mixture of several different plastic compositions. In a preferred embodiment, the steps of the present disclosure may be applied to recycle and purify polypropylene and polyethylene type plastics. In alternative embodiments, the steps of the present disclosure may be used to recycle and purify other plastics.

The reclaimed plastic may comprise various pigments, dyes, process aides, stabilizing additives, fillers, and/or other performance additives added to the original plastic.

The system and method depicted in FIG. 1 includes a feed loading system 102 to convert solid reclaimed plastic material into a molten (liquid) plastic. The feed loading system 102 comprises an extruder and a conveyor system (such as a pneumatic pump or belt driven conveyor belt) to move various quantities of plastic efficiently to the site of the extruder. In the preferred embodiment, the extruder is capable of converting the solid reclaimed plastic into a molten (liquid) plastic having a temperature of between 160° and 300° Celsius and a pressure of between 150 to 8,000 psig. After passing through the feed loading system 102, the molten (liquid) plastic enters a conveying system (such as a pipe).

The feed loading system 102 may further comprise a positive displacement pump (such as, but not limited to, a gear pump) to boost the pressure of the molten plastic downstream of the extruder. The feed loading system 102 may also comprise one or a plurality of feed hoppers added to the feed loading system to control the flow rate of reclaimed plastics into the extruder. Further, nitrogen may be fed into the feed loading system 102 to purge air from the reclaimed plastic before it is extruded into a liquid. The feed loading system 102 may further comprise one or more solids filters upstream and/or downstream of the extruder to remove foreign bodies from the reclaimed plastic. As a non-limiting example, the solids filter may comprise a series of magnets or metal detectors to remove solids from the flow of reclaimed plastics. In addition, the feed loading system 102 may further comprise a vacuum system at the entrance of the extruder to remove residual moisture from the reclaimed plastic.

### Solvent Contacting

The system and method depicted in FIG. 1 includes a solvent contacting step 104 which brings the molten (liquid) plastic into physical contact with a solvent to extract contaminants from the molten (liquid) plastic. In the preferred embodiment, the solvent has a boiling point of less than 70° Celsius and the molten (liquid) plastic is at a temperature of between 70° to 280° Celsius and a pressure of between 150 to 8,000 psig.

The solvent contacting step 104 may be accomplished through injection of the solvent into any of: a pipe conveying the molten plastic, a static mixer with fixed mixing elements, an agitated vessel, or similar device. For any of the aforementioned devices, for optimal results heat jacketing or an upstream heat exchanger (or both) maintain the temperature during the solvent contacting step 104.

In an embodiment of the present invention, the solvent is selected from the group consisting of carbon dioxide, ketones, alcohols, ethers, esters, alkenes, alkanes and mixtures thereof. The selection of the solvent used will dictate the pressure and temperatures used to perform the steps of the present invention.

In an embodiment of the present invention, the contacting step 104 optimally includes at least 10 minutes of residence time. In a further embodiment, the solvent injection rate corresponds to the saturation concentration of the molten plastic.

### Solvent Extraction

In an embodiment of the present invention, the system and method 100 include an extraction step 106 which brings the molten plastic-solvent mixture into further contact with an additional stream of solvent at a temperature of between 70° to 280° Celsius and a pressure of between 150 to 8,000 psig. Upon contact with the molten plastic, the solvent diffuses into the molten plastic for the purpose of extracting contaminants. Once the solvent diffuses into the molten plastic, high solubility contaminants within the molten plastic transfer and dissolve into the solvent. In an embodiment of the present invention, the temperature, pressure, and solvent ratio are controlled such that the plastic does not completely dissolve in the solvent.

The extraction of the molten plastic with the solvent uses a vessel configured to allow for continuous extraction of the plastic with the solvent. In an embodiment, the vessel incorporates mechanical agitation. Mechanical agitation refers to the use of a moving surface inside the vessel. Mechanical agitation may be accomplished with many types of surfaces including, but not limited to, surfaces comprising the following shapes: double helix, flat paddles, pitched blade, or an impeller. In further embodiments, the vessel may be designed with a length-to-diameter ratio greater than 1. In additional alternative embodiments the vessel may comprise horizontal internals positioned perpendicular to the bulk flow of the molten plastic.

In the preferred embodiment, the solvent extraction step 106 produces a first stream comprised of reclaimed plastic and a second stream comprised of contaminated solvent. In the preferred embodiment, the first stream of reclaimed plastic continues to move through the recycling process and the second stream of contaminated solvent moves on to a solvent recovery and purification process 120 prior to its reintroduction into the recycling process.

In the preferred embodiment, the second stream of contaminated solvent is purified, recovered, and recycled for reuse in the solvent contacting step 104, solvent extraction step 106, or solvent mixing step 108.

The period of time corresponding to the extraction step 106 is variable based on the amount of solvent used, the volume of extractable contamination, and the desired purity of the resultant plastic material.

### Solvent Mixing/Dissolution Step

In an embodiment of the present invention, the system and method 100 include dissolving the reclaimed plastic in a solvent at a temperature of about 70° to 280° Celsius and a pressure of about 200 to 8,000 psig.

The dissolution step 108 begins the removal of insoluble contaminants from the reclaimed plastic. During the dissolution step 108, additional solvent is introduced to the reclaimed plastic along with a change in the temperature, pressure, or both in order to create conditions in which the reclaimed plastic will dissolve to form a plastic-solvent solution while certain contaminants remain insoluble. In alternative embodiments, the Solvent Mixing/Dissolution Step may utilize additional mixing mechanisms, including but not limited to agitation vessels, static mixers, acoustic mixers, or recirculating pump loops.

Product Settling Step

In an embodiment of the present invention, the system and method 100 include separating undissolved contaminants from the plastic-solvent solution via a settling step 110 at a temperature of 70° to 280° Celsius and a pressure of about 200 to 8,000 psig. Gravity or another force (i.e., centrifugal or centripetal force) moves the undissolved contaminants in a particular direction, separating the contaminants from the plastic-solvent solution. Settling time varies based on the size and density of the contaminants and the density and viscosity of the plastic-solvent solution. In a preferred embodiment, the contaminants collect in the bottom of the settling vessel. In other embodiments, the contaminants flow continuously through an outlet in the bottom of the settling vessel (i.e., Heavy Byproduct) 111. In additional alternative embodiments, the settling vessel may utilize a mechanical auger or impeller, melt pump, extruder, or scraping device to convey the solids along the bottom of the vessel. In the preferred embodiment the settling step employs a pressure vessel large enough to provide at least 5 minutes of residence time.

After the plastic-solvent solution passes through the settling step 110, all other plastics except for plastic(s) which the user desires to purify should be removed from the plastic-solvent solution (or at most may remain in negligible amounts).

### Product Filtration Step

In an embodiment of the present invention, the system and method 100 includes filtering the plastic-solvent solution at a temperature of about 70° to 280° Celsius and a pressure of about 200 to 8,000 psig to remove fine particles from the plastic-solvent solution. In a preferred embodiment, the filtering step 112 is accomplished with a filtration system comprising a filter media and filter container with an inlet and an outlet. In an alternative embodiment, more than one filter assembly is incorporated into the design of the filtration system. In the alternative embodiment, multiple filters enable a user to temporarily take some, but not all, filters offline for regeneration without interrupting the recycling process. In an additional alternative embodiment, the filter assembly further comprises a filter aid used to increase the efficiency of filtration.

In another embodiment, to prepare a filter for separation at large scale, a separate mixing vessel is used to suspend the filter aid in the appropriate solvent so that it may applied as a pre-coat. The mixing vessel is connected to the filter assembly so that the suspension of solvent and filter aid can be recirculated through the filter in order to form a pre-coat layer of filter aid on the filter surface. The filtration step 112 may employ multiple filter assemblies that are all connected to the filter aid circulation system in a way that any filter assembly can be taken offline and introduced to the pre-coating process, while the remaining filter assemblies remain active in the purification process.

### Product Purification Step

In the preferred embodiment of the present invention, the system and method 100 includes a purification step 114, wherein the plastic-solvent solution is contacted with a solid, absorbent media at a temperature of about 70° to 280° Celsius and a pressure of about 200 to 8,000 psig. The solid media comprises particles that remove at least some of the remaining contamination from the plastic-solvent solution. In an embodiment, this step incorporates a plurality of adsorbent vessels. The plurality of vessels allow a user to temporarily remove some, but not all, of the adsorbent vessels for regeneration without interrupting the recycling process. In the preferred embodiment, each adsorbent vessel can be taken offline individually to enable regeneration or replacement of the adsorbent media. In one embodiment, each adsorbent vessel is connected to a solid conveying system that can deliver adsorbent media to the vessel at a rate greater than 50 lbs/hr. In another embodiment of the purification step, each adsorbent vessel is equipped with a secondary outlet that allows used adsorbent media to be removed by gravity and taken to a solid conveying system. The solid conveying systems used in this service may include conveyer belts, silos, hoppers, pneumatic conveyers, ducts, and/or other similar means.

### Product Decanting

In the embodiment depicted in FIG. 1, the system and method 100 includes a product decanting step 116 to separate the solvent and molten plastic. The product decanting step 116 changes the temperature and/or pressure to create conditions for the molten plastic to precipitate out of the plastic-solvent mixture. The solvent is recovered, while the molten plastic continues to the devolatization step 118. In a preferred embodiment, the product decanting step 116 operates at a temperature between 70° to 280° Celsius and a pressure between 200 to 8,000 psig.

During the decanting step 116, the plastic-solvent solution enters a decanter vessel. The decanter vessel comprises a low point outlet for the molten plastic and a high point outlet for the liquid solvent. After the plastic-solvent solution enters the decanter vessel, the solvent and plastic separate by density. The plastic, which is more dense than the solvent, falls to the bottom of the vessel and the solvent floats to the top of the vessel. In an alternative embodiment, the decanter vessel may comprise coalescing elements to assist with the separation of the plastic and the solvent. In an additional alternative embodiment, the decanter vessel could have a length-to-diameter ratio greater than 1.

In an embodiment of the present invention, the decanter vessel may further comprise a heat exchanger to control the temperature of the plastic-solvent mixture. In addition, the decanter vessel may further comprise a control valve or a pump to control the pressure of the molten plastic-solvent mixture.

In further embodiments, the decanter vessel may comprise a level transmitter capable of identifying the plastic-solvent mixture interface and a flow control valve or a pump to maintain the level of molten plastic in the decanter vessel. The decanter vessel may be further equipped with a steam jacket to maintain a desired temperature.

In an embodiment of the present invention, the decanter vessel comprises a total volume sufficient to provide at least 1 minute of residence time. In addition, the decanter vessel may comprise internal flow restriction panels at the inlets and/or outlets.

### Product Devolatilization

In the embodiment depicted in FIG. 1, the system and method 100 includes a product devolatilization step 118 to remove remaining solvent from the molten plastic recovered from the decanting step 116. In a preferred embodiment, the product devolatilization step 118 operates at a temperature between 70° to 280° Celsius and a pressure between 0 to 2,000 psig to vaporize and remove solvent from the molten plastic recovered from the decanting step 116.

The product devolatilization step 118 comprises one or more heat exchangers to increase the temperature of the molten plastic, a pressure control valve to reduce the pressure of the molten plastic, and a devolatilization vessel. The devolatilization vessel comprises an inlet for the molten plastic recovered from the decanting step 116, a solvent vapor outlet proximate the top of the devolatilization vessel, and a molten plastic outlet proximate the bottom of the devolatilization vessel. In the devolatilization vessel, the remaining solvent vaporizes from the molten plastic. The solvent exits the solvent vapor outlet and is directed to a solvent recovery and purification step 120. The molten plastic that exits the product devolatilization step 118 is taken to final product processing 122. Final product processing includes a plurality of steps which are common in plastic production, including but not limited to, pelletization, degassing, additive addition, or compounding.

In an embodiment of the present invention, the devolatilization vessel comprises a heat exchanger and/or heat jacket to maintain a desired temperature.

In further embodiments, the devolatilization vessel may comprise a sloped bottom outlet at least 63 degrees off the bottom face of the vessel. The devolatilization vessel may further comprise a sonic level transmitter.

### Solvent Recovery and Purification

In the embodiment depicted in FIG. 1, the system and method 100 includes a solvent recovery and purification step 120 to recycle the solvent and remove contaminants from the solvent recovered from the product decanting 116, devolatilization 118, and/or solvent extraction 106 steps.

The solvent recovery and purification step 120 consists of one or more solvent flash vessels operating at a temperature between 50° and 200° Celsius and a pressure between 0 to 200 psig. The solvent flash vessels vaporize the solvent and separate the solvent from liquid and solid contaminants.

In a preferred embodiment, each solvent flash vessel comprises a high point outlet for vapor solvent and a low point inlet for vapor liquid. One or more of the solvent flash vessels also could include a low point outlet for a Light Byproduct 121.

Each solvent flash vessel may likewise include an inlet for Makeup Solvent 119.

In the preferred embodiment, one or more solvent flash vessels could be jacketed so that a heat transfer medium including but not limited to steam or hot oil can be used to maintain the temperature of the vessel.

In some embodiments, a pre-heater may be employed on the inlet of one or more of the solvent flash vessels in order to superheat the contaminated solvent stream to a temperature between 150° and 400° Celsius.

In some embodiments, filters proximate the outlet for the vapor solvent from one or more of the solvent flash vessels capture solid and liquid contaminants.

In a preferred embodiment, the solvent recovery and purification step 120 also includes one or more heat exchangers to condense the solvent to a liquid for collection in one or more liquid collection vessels. These liquid collection vessels operate at a temperature of −100° and 50° Celsius and a pressure from 0 to 150 psig. Makeup solvent 119 can be introduced to one or more of these liquid collection vessels.

In some embodiments, multiple solvent collection vessels are used to condense the solvent in stages. In these embodiments, these collection vessels have a high point outlet for vapor solvent and a low point outlet for liquid solvent. In some embodiments, an additional heat exchanger is used to condense the vapor solvent for collection in the next liquid collection vessel. In some embodiments, a pump is used to move the liquid solvent to the next collection vessel.

In some embodiments either the vapor solvent leaving the collection vessel or the liquid solvent is passed through a filter.

In an embodiment of the present invention, the solvent collection vessel(s) may comprise a heat jacket to maintain a desired temperature.

In the preferred embodiment, the solvent recovery and purification step 120 includes solvent pressurization comprising one or more pumps to recycle the captured solvent back into the purification process. In a preferred embodiment, the solvent pressurization step operates at a temperature of about 0° to 50° Celsius and a pressure between 200 to 8,000 psig. In the preferred embodiment, the solvent is introduced back into the purification process at the solvent contacting 104 and solvent extraction 106 and solvent mixing 108 steps.

In an embodiment of the present invention, the one or more pumps may include, but are not limited to, a plunger-style displacement pump, vertical turbine pump, centrifugal pump, and/or rotary gear pump.

In some embodiments, the solvent recovery and purification step 120 may include a distillation column including multiple equilibrium stages. In these embodiments, the distillation column would produce additional Light Byproduct material 121. In these embodiments, the distillation column would also produce a purified solvent stream that would be fed to the solvent collection vessel(s).

### Alternative System and Method for Purifying Contaminated Plastics

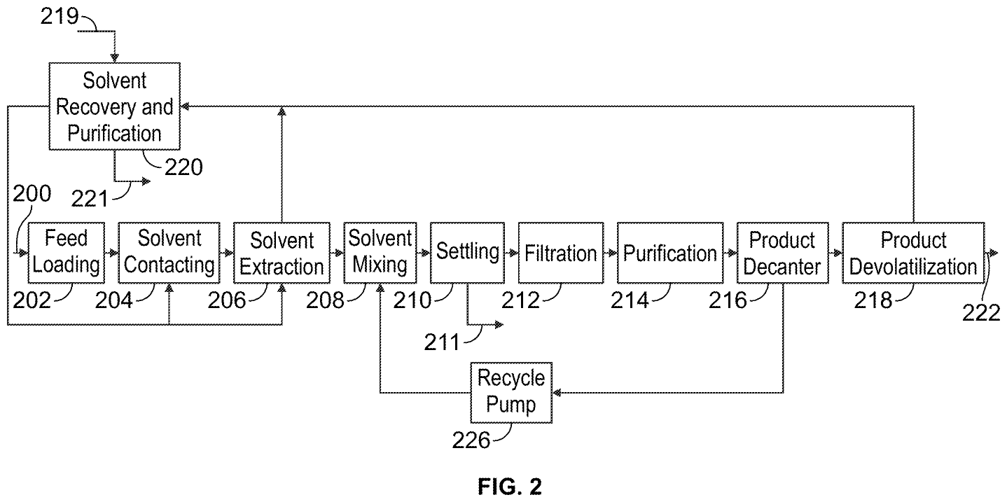

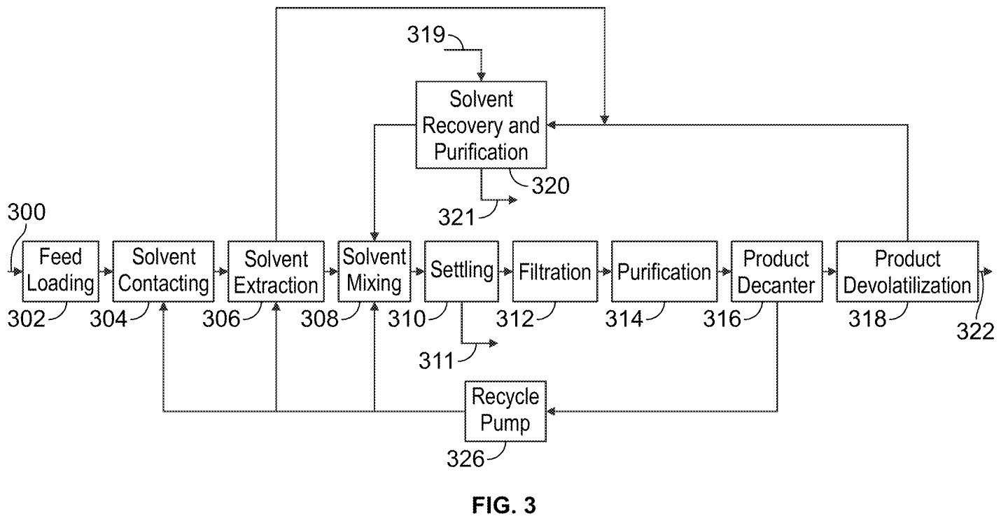

FIGS. 2 and 3 depict alternative systems and methods for a continuous dissolution recycling process 200 and 300. These alternative embodiments comprise similar elements described in FIG. 1 and, unless otherwise noted, similarly labeled elements refer to similar steps (i.e., feed loading step 100, 200, 300).

FIG. 2 depicts an alternate system and method for a continuous dissolution recycling process 200. The embodiment depicted in FIG. 2 includes a recycling pump 226 to maintain the flow of solvent throughout the purification process. In the preferred embodiment, the recycling pump 226 recovers liquid solvent from the product decanting step 216 and reintroduces the liquid solvent to the purification process at the solvent mixing/dissolution step 208. In this way, the recycled solvent is reintroduced to the process without being flashed. The at least one recycling pump 226 may include, but is not limited to, a plunger-style displacement pump, vertical turbine pump, centrifugal pump, and/or rotary gear pump. The recycling pump 226 may further comprise one or more heat exchangers to condition the temperature of the recovered solvent to match the temperature of the solvent in the solvent mixing step 208.

The system and method 200 of FIG. 2 comprises a feed loading step 202, a feed contacting step 204, a solvent extraction step 206, a solvent mixing/dissolution step 208, a settling step 210, a filtration step 212, a purification step 214, devolatilization step 218, and a solvent recovery and a solvent recovery and purification step 220.

Similar to the system and method of FIG. 1, the settling step 210 includes a Heavy Byproduct stream 211 and the solvent recovery and purification step 220 includes an inlet for Makeup Solvent 219 and an outlet for Light Byproduct 221. However, in the system and method 200 of FIG. 2, the solvent recovery and purification step 220 reintroduces solvent back into the purification process at the solvent contacting 204 and solvent extraction 206 steps and the recycling pump 226 reintroduces solvent into the solvent mixing/dissolution step 208.

The molten plastic that exits the Product Devolatilization step 218 moves on to final product processing 222.

FIG. 3 depicts an alternate system and method for a continuous dissolution recycling process 300. The system and method 300 of FIG. 3 comprises the same steps as the system and method 200 of FIG. 2 with the addition of a more extensive solvent recycling system. In this embodiment, solvent from the recycled pump step 326 recycles solvent taken from the product decanting step 316 into the solvent contacting step 304, the extraction step 306, and the solvent mixing step 308. In this embodiment, solvent from the solvent recovery and purification step 320 is directed to the solvent mixing step 308 in order to control the pressure in the recycle loop.

The system and method 300 of FIG. 3 further comprises a feed loading step 302, solvent contacting step 304, solvent extraction step 306, solvent mixing/dissolution step 308, settling step 310, filtration step 312, purification step 314, product decanting step 316, devolatilization step 318, solvent pressurization step 324, and recycle pump 326 similar to that of the system and method 200 of FIG. 2. Also similar to the system and method 200 of FIG. 2, the settling step 310 includes a Heavy Byproduct stream 311 and the solvent recovery and purification step 320 includes an inlet for Makeup Solvent 319 and an outlet for Light Byproduct 321. However, in the system and method 300 of FIG. 3, the solvent recovery and purification step 320 recycles the solvent and removes contaminants from the solvent recovered from the product devolatilization 318 and solvent extraction 306 steps. This recovered solvent is returned to the system via the solvent mixing step 308.

The molten plastic that exits the Product Devolatilization step 318 moves on to final product processing 322.

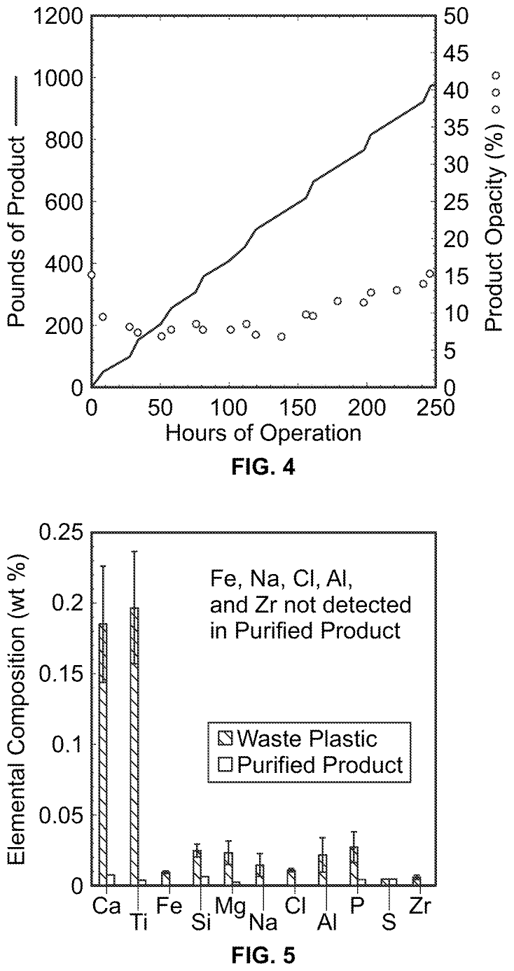

TABLE 1
Data corresponding to FIG. 4

| Hours of | Pounds of | |
|---|---|---|
| Operation | Product | Opacity |
| 0 | 0 | 15.1 |
| 8 | 50.4 | 9.5 |
| 27 | 102.5 | 8.2 |
| 33 | 153.5 | 7.4 |
| 50 | 205.1 | 6.9 |
| 57 | 255.6 | 7.8 |
| 75 | 306.1 | 8.5 |
| 80 | 356.6 | 7.8 |
| 100 | 407.4 | 7.8 |
| 112 | 458 | 8.5 |
| 119 | 508.4 | 7.1 |
| 138 | 558.8 | 6.8 |
| 156 | 608.8 | 9.8 |
| 161 | 661.2 | 9.6 |
| 179 | 713.5 | 11.6 |
| 198 | 763.9 | 11.4 |
| 203 | 815.6 | 12.7 |
| 222 | 866.5 | 13 |
| 241 | 919.7 | 13.8 |

### Illustrative Examples

### Example 1 (PR33)

Example 1 was carried out using the continuous system described in FIG. 2. In this implementation of the continuous purification process, the solvent contacting step consisted of an injection valve to introduce solvent into the flow of molten polymer with no dedicated contacting vessel. A post-consumer recycled plastic material was introduced to the purification process continuously for several days. Embodiments of the inventive process can purify about 3 to 5 pounds of plastic material per hour, although higher throughputs may be achieved. Data in FIG. 4 shows the embodiment of FIG. 2 may purify plastic material at a rate of about 3.8 to 4.7 pounds of material per hour, and overall at a rate of about 4 pounds per hour.

Furthermore, the processes described in FIGS. 1, 2, and 3 can effectively be scaled to higher production capacities and operation with high industrial reliability. The flow configurations and descriptions of the individual steps provide enough guidance to enable an implementation at any scale by employing equipment sizing methodologies known to anyone skilled in the art of chemical process design. During this period of operation, the continuous purification process maintained a high level of product quality. FIG. 4 shows the quality of the purified material produced during this operation period. The opacity of the purified plastic produced during this run was maintained below 20% over the course of the entire time period.

During this test, over 900 pounds of recycled material were fed continuously to the purification process using a feed extruder. During the time the purified product was collected, the process also produced 34 pounds of Light Byproduct and 104 pounds of Heavy Byproduct.

### Example 2 (PR42)

Inorganic contaminants may enter the plastic waste stream as fillers, additives, or colorants in addition to being accumulated through contact with other materials. The settling step is designed to remove these inorganic contaminants during the purification process.

FIG. 5 shows the average elemental content in recycled material prior to and the resultant purified plastic product after the recycling process depicted in FIG. 2. Corresponding Tables 2 and 3 depict the amount of various waste elements found in reclaimed plastic before and after the product purification in accordance with the recycling process depicted in FIG. 2.

TABLE 2
Data Corresponding to FIG. 5
Elemental Composition of Waste Plastic (% wt)

| Element | Sample 1 | Sample 2 | Sample 3 | Sample 4 | Average |
|---|---|---|---|---|---|
| Ca | 0.153 | 0.145 | 0.217 | 0.224 | 0.18475 |
| Ti | 0.163 | 0.161 | 0.233 | 0.23 | 0.2 |
| Fe | 0.011 | 0.009 | 0.008 | 0.01 | 0.01 |
| Si | 0.028 | 0021 | not | not | 0.02 |
| | | | detected | detected | |
| Mg | 0.017 | 0.015 | 0.029 | 0.032 | 0.02 |
| Na | 0.008 | 0.008 | 0.02 | 0.023 | 0.01 |
| Cl | 0.013 | 0.011 | 0.01 | 0.01 | 0.01 |
| Al | 0.013 | 0.009 | 0.033 | 0.032 | 0.02 |
| P | not | not | 0.019 | 0.035 | 0.03 |
| | detected | detected | | | |
| S | 0.005 | not | 0.005 | 0.005 | 0 |
| | | detected | | | |
| Zr | 0.005 | not | 0.007 | 0.007 | 0.01 |
| | | detected | | | |
| O | 0.241 | 0.214 | 0.005 | | 0.15 |

TABLE 3
Data Corresponding to FIG. 5
Elemental Composition of Purified Product (% wt)

| Element | Sample 1 | Sample 2 | Average |
|---|---|---|---|
| Ca | 0.0069 | 0.0087 | 0.0078 |
| Ti | not detected | 0.004 | 0.004 |
| Fe | not detected | not detected | not detected |
| Si | 0.007 | not detected | 0.007 |
| Mg | not detected | 0.002 | 0.002 |
| Na | not detected | not detected | not detected |
| Cl | not detected | not detected | not detected |
| Al | not detected | not detected | not detected |
| P | 0.005 | not detected | 0.005 |
| S | not detected | 0.005 | 0.005 |
| Zr | not detected | not detected | not detected |
| O | 0.021 | not detected | 0.02 |

### Example 3 (PR 47)

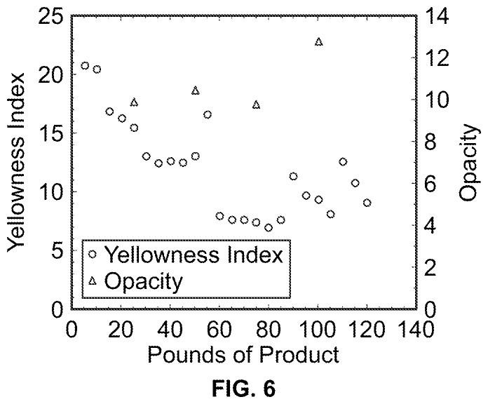

The solvent recovery and purification steps 120, 220, and 320 depicted in FIGS. 1, 2, and 3 facilitate the removal of contaminant molecules from the solvent and allow for continuous purification of the waste plastic. The solvent recovery and purification steps 120, 220, 320 remove contaminants that are typically found in plastic waste streams including but not limited to phthalates, alkylphenols, primary aromatic hydrocarbons, pesticides, and bisphenols. The solvent requires continuous purification in order for the dissolution recycling process to be continuous. During operation of the continuous process described in FIG. 2, data was taken before and after being purified. During this test, over 1300 pounds of material were fed to the purification process, producing over 800 pounds of purified material. FIG. 6 and corresponding Table 4 display quality data from 120 pounds of product added to the purification system described in FIG. 2 after about 48 hours of operation.

TABLE 4
Data Corresponding to FIG. 6

| Product Weight | YI | Opacity |
|---|---|---|
| (Cumulative) | (<20) | (<20) |
| 5 | 20.67 | |
| 10 | 20.36 | |
| 15 | 16.66 | |
| 20 | 16.07 | |
| 25 | 15.25 | 9.8 |
| 30 | 12.79 | |
| 35 | 12.19 | |
| 40 | 12.36 | |
| 45 | 12.25 | |
| 50 | 12.81 | 10.4 |
| 55 | 16.42 | |
| 60 | 7.68 | |
| 65 | 7.35 | |
| 70 | 7.34 | |
| 75 | 7.15 | 9.7 |
| 80 | 6.70 | |
| 85 | 7.36 | |
| 90 | 11.10 | |
| 95 | 9.45 | |
| 100 | 9.08 | 12.8 |
| 105 | 7.85 | |
| 110 | 12.37 | |
| 115 | 10.53 | |
| 120 | 8.84 | |

As discussed above, the continuous dissolution recycling process requires continuous recycling and purification of solvent, which is in turn used to purify and recycle the reclaimed plastic. During the 48 hours of operation during which the reclaimed plastic in FIG. 6 was being purified, most of the solvent used in purification was recovered and recycled. Table 5 shows quantity of solvent used during this time period and the recovery of solvent during 48 hours of operation. This data shows that an embodiment of the present invention is capable of recovering over 97% of the solvent used in the process. The data of Table 5 corresponds to the process depicted in FIG. 2.

TABLE 5

| | |
|---|---|
| Pounds of solvent fed to Step 204 | 304 |
| Pounds of solvent fed to Step 206 | 1519 |
| Pounds of solvent fed to Step 208 | 3704 |
| Pounds of makeup solvent 219 | 193 |
| Added | |
| Percentage of solvent recovered | 97% |

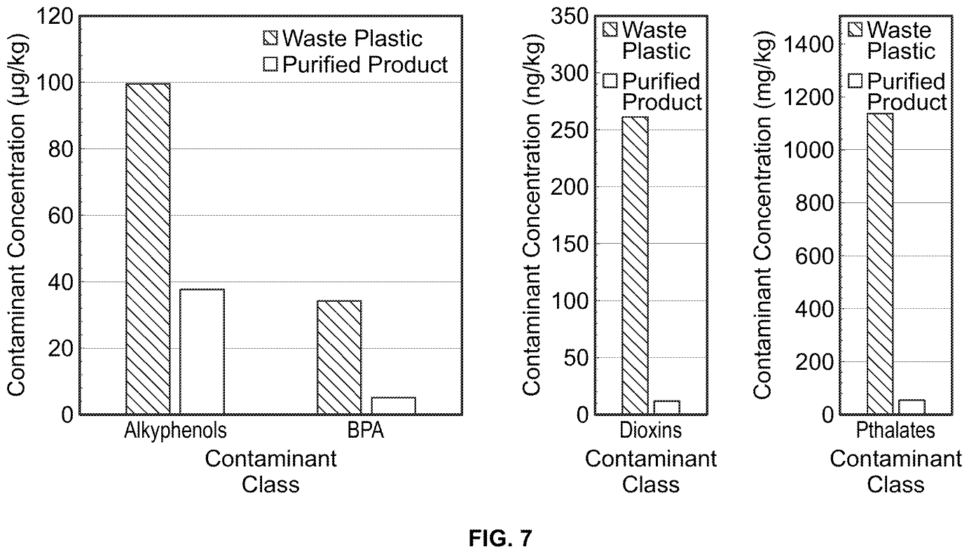

The resulting recycled plastic product was also analyzed for broader classes of contaminants. FIG. 7 provides recycled plastic product quality data, which tests for several classes of contaminants ordinarily found in recycled plastic and which must be continually removed from the solvent stream in order to generate quality recycled polyolefins. FIG. 7 shows the ability of the purification process to reduce the concentration of all contaminants and in some cases reducing the contamination level below the detectable limit.

TABLE 6a
Phthalates content in Purified Plastic and Water

| | Phthalates content in ppb (mg/kg) | | | | | | | | |
|---|---|---|---|---|---|---|---|---|---|
| Description | DPHP | DEP | DiBP | DBP | BBP | DcHP | DEHP | DiNP | Average |
| Waste Plastic | 520 | 440 | 290 | 650 | 290 | 1800 | 3100 | 2000 | 1136 |
| Purified Feed | <50 | <50 | <50 | <50 | <50 | <50 | <50 | <50 | <50 |

TABLE 6b
Alkylphenols in Waste Plastic and Purified Product

| | Aklyphenols in ppb (mg/kg) | | |
|---|---|---|---|
| Description | iso-Nonylphenol | 4-tert-Pentylphenol | Average |
| Waste Plastic | 180 | 19 | 99.5 |
| Purified Feed | <50 | 25 | 37.5 |

TABLE 6b
Dioxin and PCBs Content in Waste Plastic and Purified Product

| | 1,2,3,4,6,7,8- | | PCB | PCB | PCB | PCB | PCB | |
|---|---|---|---|---|---|---|---|---|
| Description | HpCDD | OCDD | 77 | 81 | 105 | 126 | 118 | Average |
| Waste Plastic | 1.86 | 10.2 | 264 | 10.2 | 452 | 54.6 | 1040 | 262 |
| Purified Feed | 0.2 | 0.2 | 6.46 | 0.39 | 19.2 | 0.588 | 46 | 10.4 |

TABLE 6c
BPA in Waste Plastic and Purified Plastic

| Description | BPA |
|---|---|
| Waste Plastic | 34 |
| Purified Feed | 5 |

TABLE 6d
Comparison of Average Contaminants in
Waste Plastic and Purified Product

| | Waste Plastic | Purified Product |
|---|---|---|
| Phthalates | 1136.3 | 50.0 |
| Alkyphenols | 99.5 | 37.5 |
| BPA | 34 | 5 |
| Dioxins | 261.8 | 10.4 |

### Example 4 (PR51)

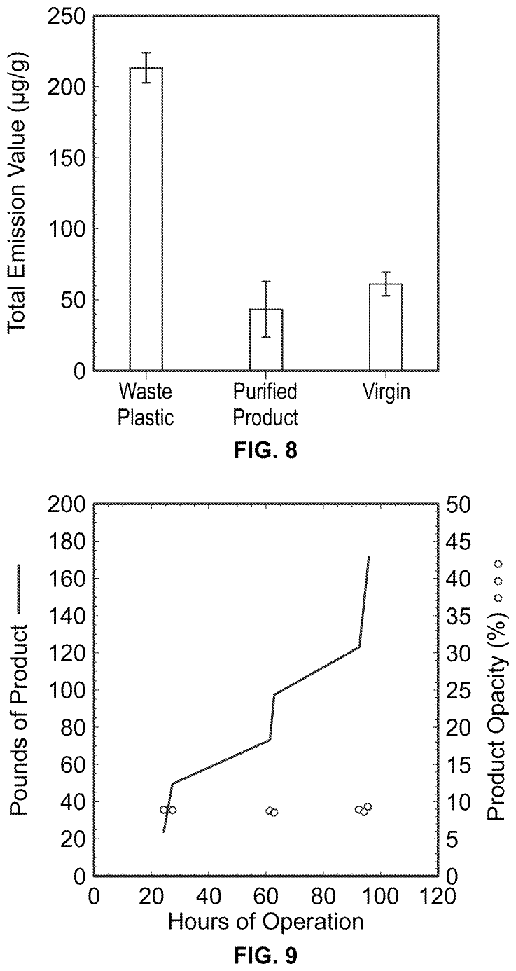

FIG. 8 depicts Gas Chromatograph results of ASTM VDA 278 (a standard automotive industry test developed by the German Automotive Industry Association) which analyze the emissions and odor of the reclaimed plastic, the resulting recycled plastic product, and sample virgin plastic. This figure illustrates the ability of the purification process to remove the volatile organic content (VOC) from waste plastic. This data was generated using the process configuration depicted in FIG. 2.

TABLE 7
Data Corresponding to FIG. 8

| Internal | External | VOC1 | VOC2 | Average | STDEVA |
|---|---|---|---|---|---|
| FT120WV | Virgin | 66.1 | 54.5 | 60.3 | 8.2 |
| (Virgin) | | | | | |
| PR5108C | Purified | 28.3 | 56.1 | 42.2 | 19.7 |
| | Product | | | | |
| Wet Line | Waste Plastic | 205 | 220 | 212.5 | 10.6 |
| Flake #4 | | | | | |
| (PR51C feed) | | | | | |

### Example 5 (PR53)

FIG. 9 depicts the amount of recycled plastic product produced and the opacity of such product over 100 hours of operation using the process described in FIG. 1. Specifically, Example 5 produced about 160 pounds of product in about 100 hours of operation as shown in FIG. 9. FIG. 9 also shows that the product quality resulted in an opacity reading of less than 20%.

TABLE 8
Data Corresponding to FIG. 9

| Product Weight | Opacity | Hours of |
|---|---|---|
| (Cumulative) | (<20) | Operation |
| 25 | 9.2 | 24.7 |
| 50 | 9.1 | 27.4 |
| 74 | 9.2 | 61.4 |
| 98 | 9.0 | 62.7 |
| 124 | 9.3 | 92.7 |
| 148 | 9.1 | 94.2 |
| 172 | 9.8 | 95.6 |

Table 9 shows the solvent fed to each of steps 104, 106, and 108 during the same 100-hour time period. The total solvent utilized is compared to the amount of makeup solvent added to the system. In this example, the solvent recovery and purification step in the process demonstrated the ability to recover over 98% of the solvent utilized to purify the product during this time, as shown in Table 9. The data of Table 9 corresponds to the process depicted in FIG. 1.

TABLE 9

| | |
|---|---|
| Pounds of solvent fed to Step 104 | 415 |
| Pounds of solvent fed to Step 106 | 1346 |
| Pounds of solvent fed to Step 108 | 4375 |
| Pounds of makeup solvent 119 added to | 105 |
| process | |
| Percentage of solvent recovered | 98% |

### Example 6 Process Simulation

Table 10 depicts results of a simulation of the continuous dissolution recycling process depicted in FIG. 3. The results were obtained using a commercial process simulation package to determine the total make-up solvent required. Make-up solvent is additional solvent required to be added to the system to maintain operations in the continuous dissolution recycling process.

Table 10 provides the mass balance for the continuous process which can be adjusted to waste plastic feeds between 1 and 100,000 lbs/hr by altering the sizing of process equipment where the subsequent Light Byproduct, Heavy Byproduct, and Make-up Solvent streams are proportional to the amount of reclaimed plastic fed into the continuous dissolution recycling process depicted in FIG. 3 (i.e., the “Waste Plastic Feed.”)

TABLE 10

| Description | Rate (lb/hr) |
|---|---|
| Waste Plastic Feed | 5,000-8000 |
| Light Byproduct 321 | 10-1000 |
| Heavy Byproduct 311 | 10-1000 |
| Make-up Solvent 319 | 20-40 |

What is claimed is:

1. A method for purifying a reclaimed plastic comprising the steps of:
a) obtaining reclaimed plastic material wherein the reclaimed plastic material is comprised of post-consumer use plastics, post-industrial use plastics, or combinations thereof;
b) contacting the reclaimed plastic with a solvent having a boiling point of less than or equal to 70 degrees Celsius to form a reclaimed plastic-solvent mixture, wherein contacting the reclaimed plastic with solvent further comprises the steps of:
i) mixing the solvent with the reclaimed plastic material; and
ii) diffusing the solvent into the reclaimed plastic material;
c) extracting contaminants from the reclaimed plastic-solvent mixture wherein extracting contaminants further comprises the steps of
i) contacting the plastic-solvent mixture with an additional solvent;
ii) absorbing dissolved contaminants from the reclaimed plastic-solvent mixture into the additional solvent to create a contaminated solvent;
iii) producing a first stream comprised of a further reclaimed plastic-solvent mixture which proceeds to the step of separating undissolved contaminants from the further reclaimed plastic-solvent mixture; and
iv) producing a second stream comprised of the contaminated solvent which proceeds to a solvent recovery and purification step;
d) dissolving the further reclaimed plastic-solvent mixture in a second additional solvent to produce a mixture of plastic-solvent solution and undissolved contaminants;
e) separating the undissolved contaminants from the further reclaimed plastic-solvent mixture by settling the further reclaimed plastic-solvent mixture in a vessel with a residence time of at least 5 minutes and filtering the further reclaimed plastic-solvent mixture through a filter media to create a second further reclaimed plastic-solvent mixture;
f) purifying the second further reclaimed plastic-solvent mixture with a solid absorbent media;
g) recovering the solvents from the second further reclaimed plastic-solvent mixture, wherein recovering the solvents from the second further reclaimed plastic-solvent mixture further comprises the steps of:
i) decanting the second further reclaimed plastic-solvent mixture to remove a portion of the solvents from the second further reclaimed plastic-solvent mixture; and
ii) devolatilizing the second further reclaimed plastic-solvent mixture to remove at least a portion of any remaining solvent from the second further reclaimed plastic-solvent mixture; and
h) recycling at least 97% of all the solvent used in the method through a solvent recovery and purification step, wherein the solvent recovery and purification step further comprises:
i) using a plurality of flash vessels to recycle the solvents and remove contaminants from the solvents recovered from the decanting, devolatilization, and extraction steps, wherein the solvent flash vessels operate at a temperature between 50 degrees and 200 degrees Celsius and a pressure between 0 to 200 psig to vaporize the solvents into a solvent vapor and separate the solvents from liquid and solid contaminants;
ii) using a plurality of heat exchangers to condense the solvent vapor to a solvent liquid for collection in a plurality of liquid collection vessels; and
iii) using a plurality of pumps to pressurize and recycle the liquid solvent back into the method.

2. A method for purifying a reclaimed plastic comprising:
obtaining reclaimed plastic material wherein the reclaimed plastic material is comprised of post-consumer use plastics, post-industrial use plastics, or combinations thereof;
contacting the reclaimed plastic with a solvent having a boiling point of less than or equal to 70 degrees Celsius to form a reclaimed plastic-solvent mixture, wherein the solvent absorbs a plurality of contaminants from the reclaimed plastic;
recovering the solvent from the reclaimed plastic-solvent mixture;
processing the reclaimed plastic to form a final plastic product having an opacity and yellowness index of less than 20; and
recycling solvent extracted from the reclaimed plastic-solvent mixture through a solvent recovery and purification step to create a purified plastic.

3. The method of purifying a reclaimed plastic of claim 2, wherein the step of contacting the reclaimed plastic with the solvent further comprises the steps of:
mixing the solvent with the reclaimed plastic material;
diffusing the solvent into the reclaimed plastic material;
separating dissolved contaminants from the plastic-solvent mixture;
removing the dissolved contaminants into a contaminated solvent stream to produce a further reclaimed plastic-solvent mixture; and
dissolving the further reclaimed plastic-solvent mixture in an additional solvent.

4. The method of purifying a reclaimed plastic of claim 3, wherein the step of dissolving the further reclaimed polymer-solvent mixture further comprises:
separating undissolved contaminants from the further reclaimed plastic-solvent mixture to create a second further reclaimed plastic-solvent mixture;
contacting the second further reclaimed plastic-solvent mixture with a solid media to remove additional contaminants leaving the purified plastic-solvent mixture; and
providing a second stream comprised of contaminated solvent to a solvent recovery and purification step.

5. The method of purifying a reclaimed plastic of claim 4, wherein the step of recovering the solvent further comprises the steps of:
decanting the purified plastic solvent mixture to remove a portion of the solvent from the purified plastic-solvent mixture to create a second purified plastic-solvent mixture; and
devolatilizing the second purified plastic-solvent mixture to remove at least a portion of any remaining solvent from the second purified plastic-solvent mixture.

6. The method of purifying a reclaimed plastic of claim 5, wherein the solvent recovery and purification step comprises:
providing a plurality of flash vessels to recycle the solvents and remove the contaminants from the solvent recovered from the decanting, devolatilization, and diffusion steps, wherein the solvent flash vessels operate at a temperature between 50 degrees and 200 degrees Celsius and a pressure between 0 to 200 psig to vaporize the solvents into a solvent vapor and separate the solvents from liquid and solid contaminants;
providing a plurality of heat exchangers to condense the solvent vapor to a recycled solvent liquid for collection in a plurality of liquid collection vessels; and
providing a plurality of pumps to pressurize and recycle the solvent liquid back into the method.

7. The method of purifying a reclaimed plastic of claim 2, wherein the solvent is a recycled solvent.

8. The method of purifying a reclaimed plastic of claim 7, wherein the method comprises recycling more than 97% of all solvent used in the method.

9. A system of recycling solvent used in connection with dissolution recycling, the system comprising:
a dissolution recycling system for recycling reclaimed plastic;
a plurality of solvent flash vessels to recover and vaporize contaminated solvent from the dissolution recycling system;
wherein, the solvent flash vessels comprise:
a high point outlet for vapor solvent and a low point inlet for vapor liquid; and
a low point outlet for contaminants and a high point inlet for makeup solvent;
a plurality of heat exchangers to condense the vaporized solvent to a purified liquid solvent;
a plurality of liquid collection vessels to collect the purified liquid solvent; and
a plurality of solvent pressurization pumps to recycle collected purified liquid solvent back into the dissolution recycling system.

10. The system of recycling solvent of claim 9, wherein the plurality of solvent flash vessels operate at a temperature of between 50 degrees and 200 degrees Celsius and a pressure of between 0 and 200 psig.

11. The system of recycling solvent of claim 9, wherein the plurality of solvent flash vessels vaporize the contaminated solvent and separate the solvent from liquid and solid contaminants.

12. The system of recycling solvent of claim 9, wherein the plurality of solvent flash vessels further comprise a heat jacket to maintain the temperature of the plurality of solvent flash vessels.

13. The system of recycling solvent of claim 9, wherein the high point outlet of the plurality of solvent flash vessels further comprises a filter to capture liquid and solid contaminants from the vaporized solvent.

14. The system of recycling solvent of claim 9, wherein the plurality of liquid collection vessels operate at a temperature of −100 degrees to 50 degrees Celsius and a pressure of 0 to 150 psig.

15. The system of recycling solvent of claim 10, wherein the plurality of liquid collection vessels further comprise a heat jacket to maintain the temperature of the plurality of liquid collection vessels.

16. A system for continuously purifying reclaimed polypropylene comprising:
an extruder capable of converting solid recycled polypropylene material into a molten polypropylene;
a pipe to carry the molten polypropylene, the pipe comprising at least one inlet to mix an initial amount of liquid solvent with the molten polypropylene;
wherein the liquid solvent mixes with the molten polypropylene to form a molten polypropylene-solvent mixture and the liquid solvent absorbs contaminants from the molten polypropylene;
a solvent extraction vessel comprising a first outlet and a second outlet to separate a first stream of recovered molten polypropylene from a second stream of the contaminated liquid solvent;
a settling vessel comprising an outlet at the bottom of the settling vessel to remove undissolved contaminants from the recovered molten polypropylene to create a further recovered molten polypropylene;
a decanter vessel to collect and decant the further recovered molten polypropylene, the decanter vessel comprising a first outlet for the purified molten polypropylene and a second outlet for recovered liquid solvent;
a devolatization vessel to remove solvent vapor from the purified molten polypropylene, the devolatization vessel comprising a first outlet for solvent vapor and a second outlet for further purified molten polypropylene;
at least one solvent flash vessel to vaporize solvent and separate liquid and solid contaminants;
wherein the at least one solvent flash vessel comprises a high point outlet for vapor solvent and a low point inlet for liquid vapor;
at least one condensation vessel to condense the vapor solvent into a liquid;
at least one solvent pump to return an amount of liquid solvent to the system; and
wherein the ratio of liquid solvent returned to the system is at least 90% of the solvent used.

17. The system for continuously purifying reclaimed polypropylene of claim 16, further comprising at least one adsorbent vessel, the adsorbent vessel comprising a solid adsorbent media to remove contaminants from the recovered molten polypropylene.

18. The system for continuously purifying reclaimed polypropylene of claim 16, further comprising a recycling pump to maintain a desired pressure of solvent throughout the system.

19. The system for continuously purifying reclaimed polypropylene of claim 16, wherein
the solvent vapor exits the first outlet of the devolatization vessel and proceeds to the at least one solvent flash vessel; and
the further purified molten polypropylene exits the second outlet of the devolatization vessel for final processing.

20. The system for continuously purifying reclaimed polypropylene of claim 16, wherein the solvent flash vessel further comprises:
a heat jacket to maintain the temperature of the solvent flash vessel; and
a pre-heater employed at the inlet of the solvent flash vessel to superheat the solvent to a temperature between 150 degrees and 400 degrees Celsius.
